(19) United States
(12) Patent Application Publication
(10) Pub. No.: US 2026/0284848 A1
(43) Pub. Date: Sep. 24, 2026

(54) METHOD FOR OPERATING A HYDRODYNAMIC COMPRESSION TOOL AND HYDRODYNAMIC COMPRESSION TOOL

(71) Applicant: CEMBRE S.P.A., Brescia (IT)

(72) Inventors: Gualtiero BAREZZANI, Brescia (IT); Cesare BRAGA, Brescia (IT); Davide NICOLAI, Brescia (IT)

(21) Appl. No.: 19/472,075

(22) PCT Filed: Apr. 9, 2024
(86) PCT No.: PCT/IB2024/053459

§ 371 Date: Oct. 2, 2025

(30) Foreign Application Priority Data
May 18, 2023 (IT) 102023000010065

(51) Int. Cl. B25B 27/14; F15B 15/14; F15B 15/18; F15B 19/00; H01R 43/042

(52) U.S. Cl. CPC B25B 27/146; F15B 15/1428; F15B 15/1447; F15B 15/18; F15B 19/00; H01R 43/042

(57) ABSTRACT

A method for operating a hydrodynamic compression tool (1) comprises moving a compression jaw (9) towards an abutment jaw (8) by actuating the hydraulic pump (18), detecting the pressure (p) of a hydraulic fluid acting on the piston (13), identifying a compression start condition when the abutment jaw (8) and the compression jaw (9) both engage an object (11) to be compressed, detecting the pressure (p) of the hydraulic fluid acting on the piston (13) in a piston advancement step (F1) without compression up to the occurrence of the compression start condition, determining a value of compression start position (22) of the piston (13) in the compression start condition, determining an operating parameter or a compression completion criterion depending on the compression start position (22).

The present invention relates to a method for operating a hydrodynamic compression and/or cutting tool, as well as a hydrodynamic compression tool configured to implement the method.

In order to perform certain connection operations, for example, compressing connectors about electric cables, compressing rivets, or cutting operations, for example, cutting electric cables when installing and servicing electrical systems, hydrodynamic compression or crimping tools actuated by a motor are often used.

Such tools usually comprise an electric motor supplied by an accumulator and provided with a motor shaft connected to a transformation mechanism which transforms the rotary motion of the motor shaft into an alternating translational motion which causes, in a hydrodynamic unit connected thereto, an increase in pressure of a hydraulic fluid acting on a piston for moving the latter against the force of a return spring. The piston is in turn connected to a movable jaw (for example, in the shape of a punch) so as to move it towards a fixed jaw of the tool during the compression operation. The jaws can be shaped and/or provided with interchangeable accessory elements so as to be adapted to a specific product, an electrical contact to be crimped, for example.

Since compression tools are quite often used in outdoor environments, for example, along remote railways lines from buildings provided with a connection to the electrical network, they require their own source of electricity, i.e., a portable electric accumulator integrated in or applied to the tool. Such an accumulator provides a limited quantity of electricity which determines the autonomy, i.e., the number of compression/cutting operations executable by the tool without the need to replace the accumulator. It is thus desirable to perform the compression using electricity not exceeding that required and sufficient for the type of object, e.g., electrical contact, to be compressed by the planned compression stroke and force.

Compression tools without interchangeable compression dies are known (so-called “dieless” compression tools), which determine a predetermined or manually settable or adjustable (for example, selecting the actuation time of the tool and the interruption time of the actuation) stroke of the jaws and a maximum compression force, or determined with the aid of sensors, for example, position sensors of the jaws or the piston (encoder) and by monitoring the pressure of the hydraulic fluid by means of a pressure sensor.

A known compression tool adapts to the size of the connector to be compressed and always applies—independently of the contact type and size—the same maximum compression force which when reached, causes an interruption in the compression (or crimping) cycle and a return of the piston.

A further known compression tool adapts to the size of the connector to be compressed and applies a variable maximum compression force depending on a “determination of status” by measuring the stroke distance of the piston and the pressure of the hydraulic fluid or by integrating a value of force on the stroke distance of the piston. An encoder is provided to this end, which however increases the overall axial volume of the tool.

Despite their satisfactory operation and their reliability and robustness, the “dieless” tools of the prior art still have certain drawbacks.

The known “dieless” tools applying a constant maximum compression force have the disadvantage of excessive consumption of electricity and mechanical stresses not required in case of compressions of objects (electrical connectors) of intermediate and small sizes for which smaller compression forces than the maximum compression force of the tool would be sufficient.

The known “dieless” tools adapting the compression force to the size of the object (electrical contact) to be compressed require auxiliary sensors (e.g., encoders) in order to ensure a satisfactory detection accuracy of the type or size of the object to be compressed.

Therefore, it is the object of the present invention to provide a method for operating a hydrodynamic compression tool and a hydrodynamic compression tool having features such so as to obviate at least some of the drawbacks mentioned with reference to the prior art.

lt is a particular object of the invention to provide a method and a hydrodynamic compression tool which allow an automatic adaptation of the tool in case of a change in size of the product to be crimped.

lt is a further particular object of the invention to provide a method and tool which allow the adaptation of the hydrodynamic compression tool to objects to be crimped within a broad size (diameter) range with increased accuracy in the (dimensional) identification of the object.

lt is a further particular object of the invention to provide a method and tool which allow the adaptation to objects to be compressed with different sizes by a mainly software implementation, i.e., using and processing data already available in known tools, without requiring particular structural adaptations.

These and other objects are achieved by a method for operating a hydrodynamic compression tool (1), said tool (1) comprising:
an abutment jaw (8) and a compression jaw (9) movable with respect to the abutment jaw (8) for compressing an object (11) positioned between the abutment jaw (8) and the compression jaw (9),
a hydraulic cylinder (12), a piston (13) and at least one return spring (14) which elastically pushes the piston (13) to a stroke start position (16) with respect to the hydraulic cylinder (12), where the piston (13) is connected to the compression jaw (9) and can translate with respect to the hydraulic cylinder (12) along an actuation stroke (15) between the stroke start position (16) and a stroke end position (17),
a hydraulic pump (18) with an electric motor (6) actuatable to increase the pressure of a hydraulic fluid acting in the hydraulic cylinder (12) on the piston (13) so as to move the piston (13) from the stroke start position (16) to the stroke end position (17) and thus move the compression jaw (9) towards the abutment jaw (8),
   said method comprising:
moving the compression jaw (9) towards the abutment jaw (8) by actuating the hydraulic pump (18),
detecting the pressure (p) of the hydraulic fluid acting on the piston (13),
identifying a compression start condition when the abutment jaw (8) and the compression jaw (9) both engage the object (11) to be compressed, determining a compression start position (22) of the piston (13) in the compression start condition,
determining an operating parameter or a compression completion criterion depending on the compression start position (22).

The idea underlying the invention is to combine the identification of the instant of first contact of the object to be compressed, i.e., the actual start of compression, with an identification of the position of the piston in the instant of first contact, and therefore the identification of the non-deformed size of the object (for example, of an electrical contact, cable lug, etc.) to be compressed.

The method allows an implementation mainly or completely at a software level, and thus is suitable for different structure types and concepts of hydrodynamic compression tools, in particular dieless ones.

The method allows recognizing the object, e.g., an electrical connector, a cable lug, a hydraulic connector, in a more accurate manner (in the sense of a greater dimensional resolution), and determining the operating parameters and the compression completion criteria in a more precise and accurate manner, for example, adjusting a target pressure of the hydraulic fluid and/or a target stroke of the piston and/or a target pumping action number, which is required and sufficient to complete the compression, in a more precise and accurate manner. This reduces the consumption of electricity and the mechanical stresses of the jaws and increases the autonomy (number of compressions executable by a battery charge) and useful life of the compression tool.

The object of the invention is also achieved by a hydrodynamic compression tool (1), comprising:
an abutment jaw (8) and a compression jaw (9) movable with respect to the abutment jaw (8) for compressing an object (11) positioned between the abutment jaw (8) and the compression jaw (9),
a hydraulic cylinder (12), a piston (13) and at least one return spring (14) which elastically pushes the piston (13) to a stroke start position (16) with respect to the hydraulic cylinder (12), where the piston (13) is connected to the compression jaw (9) and can translate with respect to the hydraulic cylinder (12) along an actuation stroke (15) between the stroke start position (16) and a stroke end position (17),
a hydraulic pump (18) with an electric motor (6) actuatable to increase the pressure of a hydraulic fluid acting in the hydraulic cylinder (12) on the piston (13) so as to move the piston (13) from the stroke start position (16) to the stroke end position (17) and thus move the compression jaw (9) towards the abutment jaw (8),
a pressure sensor (25) configured to detect the pressure (p) of the hydraulic fluid acting on the piston,
an electronic control circuit (10) in signal connection with the pressure sensor (25) and the electric motor (6), said electronic control circuit (10) being configured to:
moving the compression jaw (9) towards the abutment jaw (8) by actuating the hydraulic pump (18),
detect the pressure (p) of the hydraulic fluid acting on the piston (13) by means of the pressure sensor (25),
identifying a compression start condition when the abutment jaw (8) and the compression jaw (9) both engage the object (11) to be compressed,
   determining a compression start position (22) of the piston (13) in the compression start condition,—determine an operating parameter or a compression completion criterion depending on the compression start position (22).

In order to better understand the invention and appreciate the advantages thereof, a description of non-limiting exemplary embodiments is provided below, with reference to the accompanying drawings, in which:

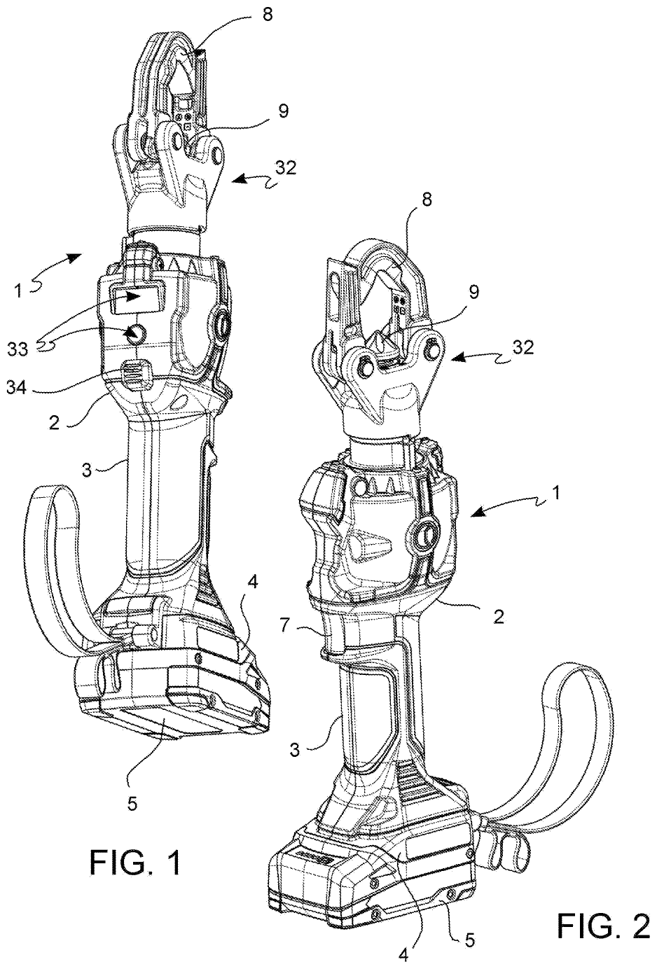

FIG. 1 is a perspective view of a hydrodynamic compression tool according to an embodiment;

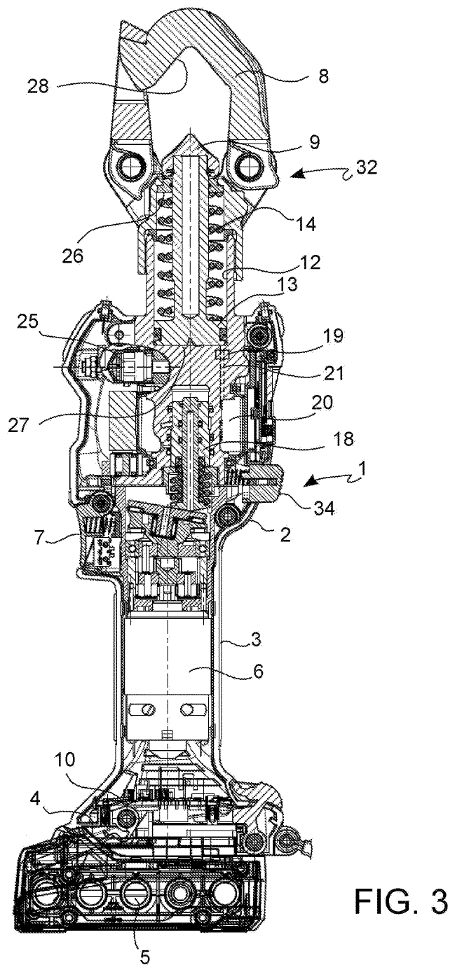

FIG. 2 is a further perspective view of the compression tool in FIG. 1;

FIG. 3 is a longitudinal section view of the hydrodynamic compression tool in FIG. 1;

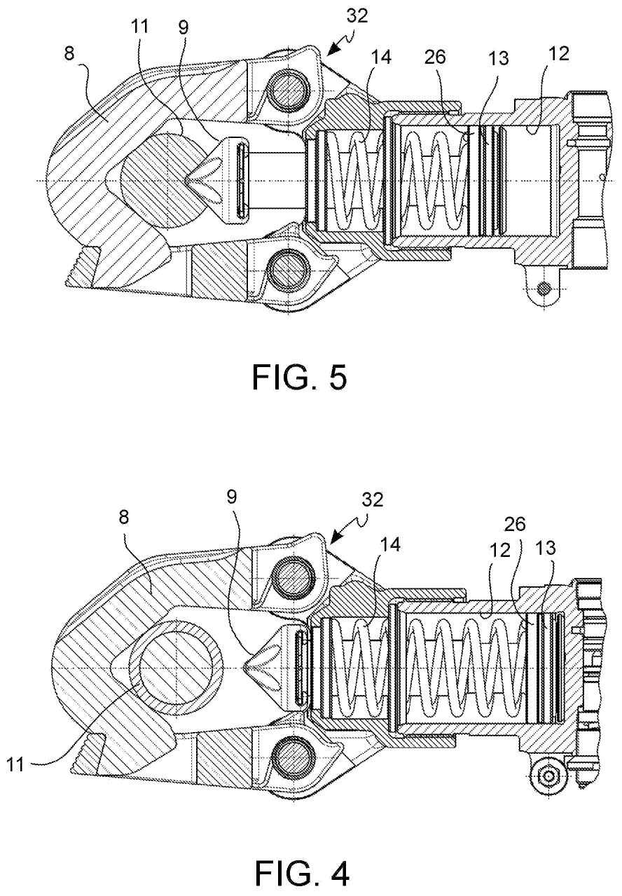

FIG. 4 shows a work head of the compression tool in FIG. 3 with piston in a stroke start position, and with a relatively large object to be compressed positioned in an abutment jaw of the work head;

FIG. 5 shows the work head of the compression tool in FIG. 3 with the piston in a compression position, in which a compression jaw (punch) of the work head partially penetrates the object to be compressed positioned in the abutment jaw;

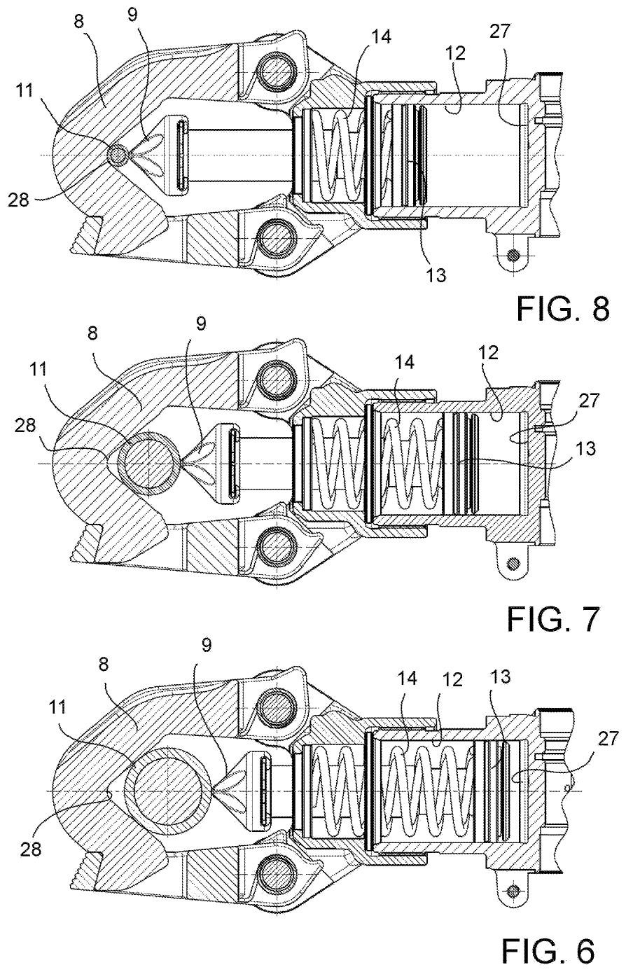

FIG. 6 shows the work head of the compression tool in FIG. 3 with the piston in a compression start position, indicative for the size of the object itself, in which the compression jaw (punch) and the abutment jaw both jointly enter a first engagement contact with the object (here, relatively large) to be compressed;

FIG. 7 shows the same situation in FIG. 6, in which the object engaged by the abutment jaw and the compression jaw is of intermediate size;

FIG. 8 shows the same situation in FIG. 6, in which the object engaged by the abutment jaw and the compression jaw is relatively small;

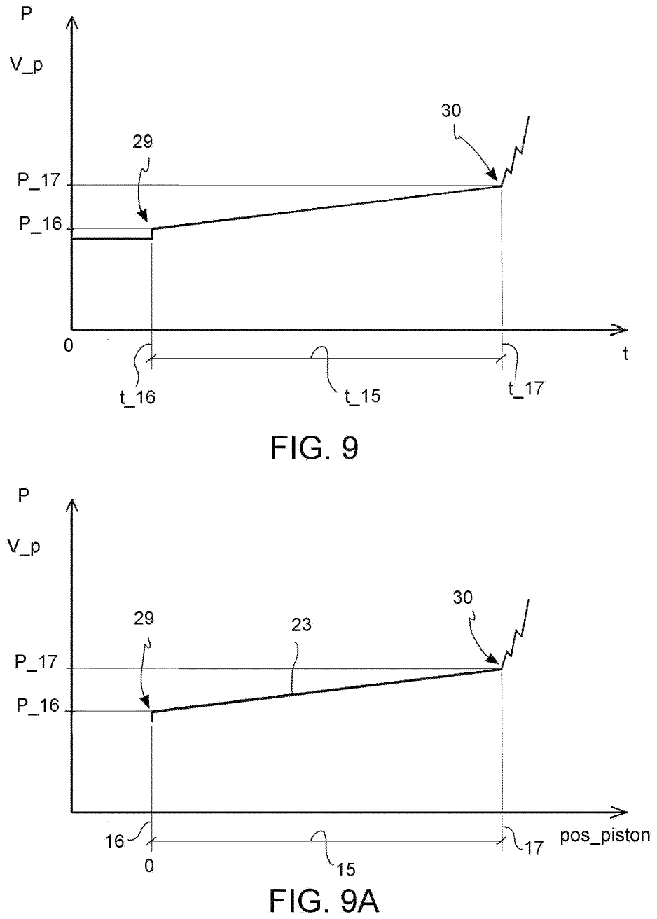

FIG. 9 is an exemplary diagram of the pressure of hydraulic fluid (ordinate) as a function of time (abscissa) during an actuation step of the hydraulic pump in case of actuation without a load (in the absence of an object to be compressed);

FIG. 9A is an exemplary diagram of the pressure of hydraulic fluid (ordinate) as a function of the position of the compression tool piston (abscissa) along an actuation stroke between a stroke start position and a stroke end position in case of an actuation without a load (in the absence of an object to be compressed), where a linear central portion of the curve is a calibration function of the compression tool;

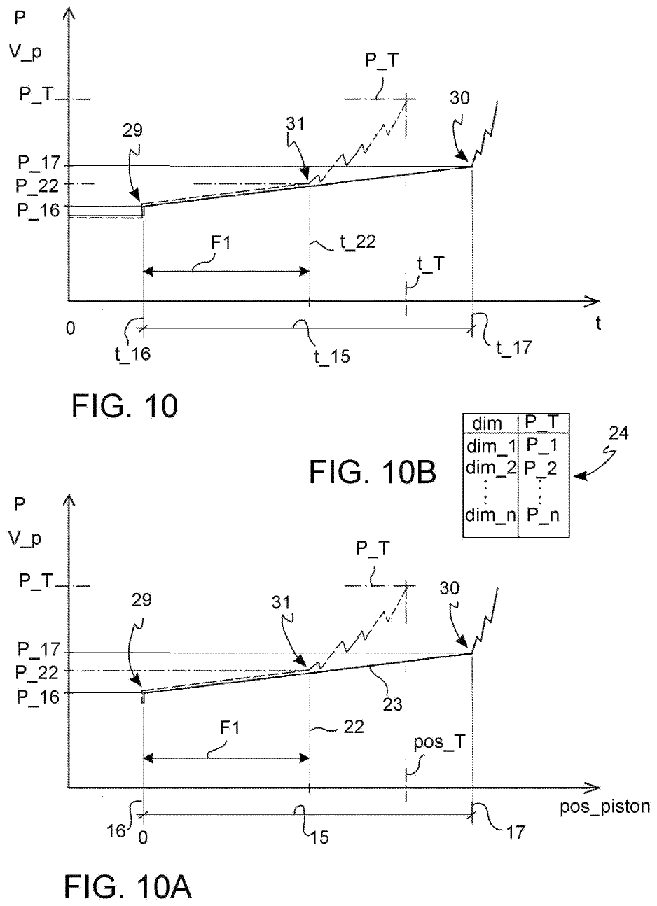

FIG. 10 is an exemplary diagram showing the pressure of hydraulic fluid (ordinate) as a function of time (abscissa) during an actuation step of the hydraulic pump in case of an actuation with compression of an object to be compressed (dashed curve), and also showing a comparative curve of the pressure trend without a load (continuous linear curve);

FIG. 10A is an exemplary diagram showing the pressure of hydraulic fluid (ordinate) as a function of the position of the piston (abscissa) along the actuation stroke in case of actuation with compression of an object to be compressed (dashed curve), and also showing a calibration function of the compression tool (portion of continuous linear curve);

FIG. 10B shows an association table between a size of an object to be compressed and a target compression, for a plurality of object sizes, according to an embodiment;

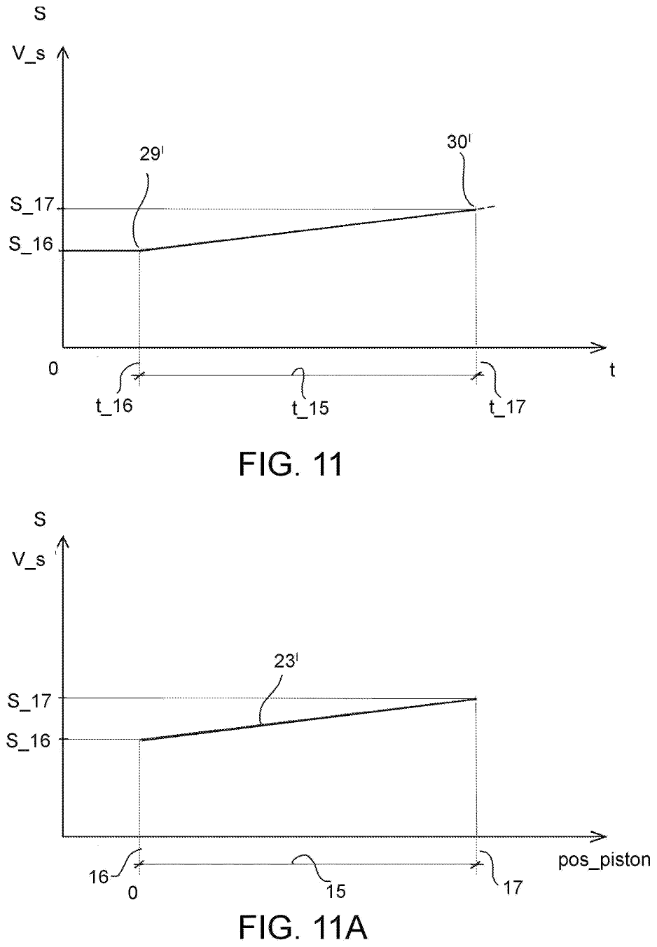

FIG. 11 is an exemplary diagram of the force of a return spring acting on a piston (ordinate) as a function of time (abscissa) during an actuation step of the hydraulic pump in case of actuation without a load (in the absence of an object to be compressed);

FIG. 11A is an exemplary diagram of the return spring force (ordinate) as a function of the position of the compression tool piston (abscissa) along an actuation stroke between a stroke start position and a stroke end position in case of actuation without a load (in the absence of an object to be compressed), where a linear central portion of the curve is a calibration function of the compression tool;

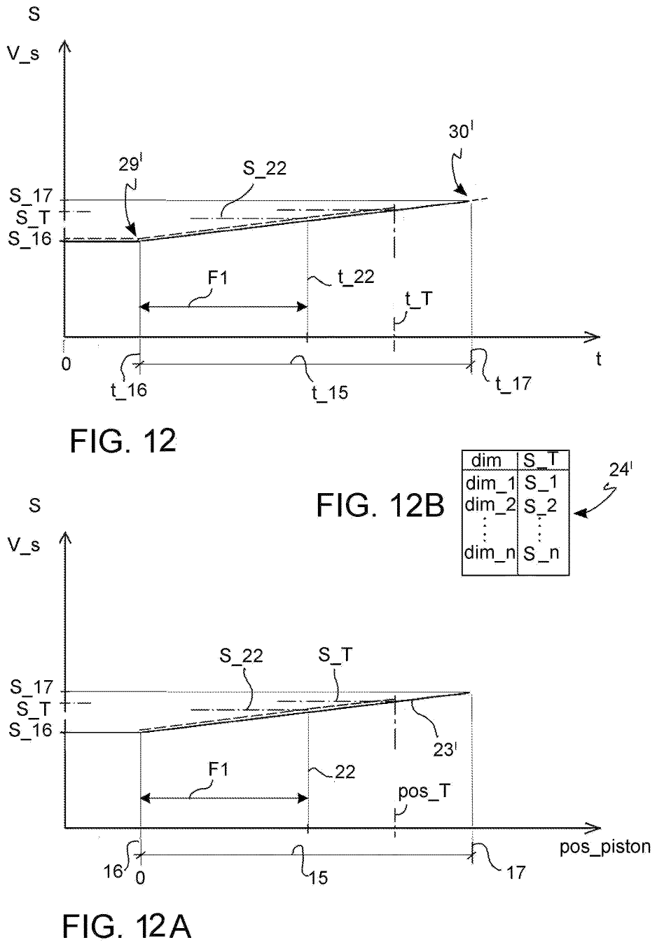

FIG. 12 is an exemplary diagram showing the return spring force (ordinate) as a function of time (abscissa) during an actuation step of the hydraulic pump in case of actuation with compression of an object to be compressed (dashed curve), and also showing a comparative curve of the trend of the return spring force without a load (continuous linear curve);

FIG. 12A is an exemplary diagram showing the return spring force (ordinate) as a function of the position of the piston (abscissa) along the actuation stroke in case of actuation with compression of an object to be compressed (dashed curve), and also showing a calibration function of the compression tool (portion of continuous linear curve);

FIG. 12B shows an association table between a size of an object to be compressed and a corresponding target force of the return spring corresponding to a target stroke of the piston, for a plurality of object sizes, according to an embodiment;

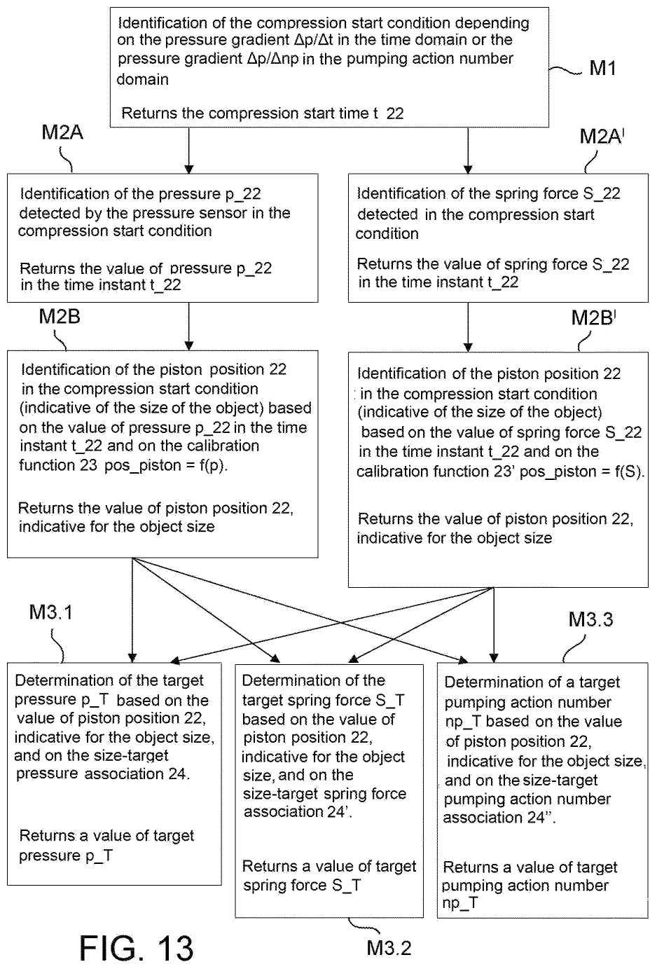

FIG. 13 shows certain significant steps of a method for operating a compression tool, according to embodiments, in which said steps can be performed according to one or more individual sequences of steps or according to combinations of sequences of steps as indicated by the arrows between the step blocks of the method.

### Description of the Compression Tool

With reference to the drawings, a hydrodynamic compression tool 1 comprises a housing 2 with a central handle-shaped portion 3 and a coupling portion 4 for the preferably snap-on connection of a replaceable and rechargeable electric battery 5 at the rear end of tool 1.

The compression tool 1 comprises an abutment jaw 8 (or fixed jaw) and a compression jaw 9 (or movable jaw) movable with respect to the abutment jaw 8 for compressing an object 11 positioned between the abutment jaw 8 and the compression jaw 9.

The compression tool 1 further comprises a hydraulic cylinder 12 and a piston 13 accommodated in the hydraulic cylinder 12, as well as a return spring 14 which elastically pushes piston 13 in a stroke start position 16 with respect to the hydraulic cylinder 12. Piston 13 is connected to the compression jaw 9 and can translate with respect to the hydraulic cylinder 12 along an actuation stroke 15 between the stroke start position 16 and a stroke end position 17.

The compression tool 1 further comprises a hydraulic pump 18 with an electric motor 6 powerable by battery 5 through a power supply and control circuit 10 having a switch on which a manual operation button 7 acts, arranged adjacent to handle 3. The hydraulic pump 18 is actuatable to increase the pressure of a hydraulic fluid acting in the hydraulic cylinder 12 on piston 13 so as to move piston 13 from the stroke start position 16 to the stroke end position 17 and thus move the compression jaw 9 towards the abutment jaw 8.

A maximum pressure valve 19 is arranged in a fluid return duct 21 which connects the hydraulic cylinder 12 to a tank 20 of the hydraulic pump 18.

The hydraulic pump 18 thus pumps the hydraulic fluid from tank 20 into the hydraulic cylinder 12 to cause piston 13, along with the compression jaw 9, to advance until reaching, in the hydraulic cylinder 12, a predetermined maximum pressure of the hydraulic fluid or until the electric motor 6 is switched OFF. Upon reaching the maximum pressure, the maximum pressure valve 19 (safety valve) automatically opens the fluid return duct 21 to discharge the pressure fluid from the hydraulic cylinder 12 into tank 20.

### Generic Description of the Method for Operating the Compression Tool

In order to facilitate the adaptation of the compression tool and process to a plurality of different products to be compressed or cut, in particular to a plurality of electrical contacts or cable lugs having different outer sizes, for example, with non-deforming outer sizes of 13 mm, 19.6 mm or 27.2 mm, the method for operating the hydrodynamic tool 1 comprises the steps of:
Moving the compression jaw 9 yowards the abutment jaw 8 by actuating the hydraulic pump 18,
detecting pressure p of the hydraulic fluid acting on piston 13,
identifying a compression start (or first engagement contact) condition when the abutment jaw 8 and the compression jaw 9 both engage the object to be compressed, for example, depending on the signals of one or more sensors of tool 1 which detect operating parameters of tool 1 or electrical parameters of an electric motor 6 of tool 1, or, for example, depending on the detected pressure p of the hydraulic fluid (FIG. 13, step M1),
determining a compression start position 22 of piston 13 in the compression start condition (FIG. 13, step M2A, M2B), for example, depending on signals of one or more sensors of tool 1 which detect operating parameters of tool 1 or electrical parameters of an electric motor 6 of tool 1,
determining an operating parameter or a compression completion criterion depending on the compression start position (22) (FIG. 13, step M3.1 and/or M3.2 and/or M3.3).

According to an embodiment, the determination of the compression start position 22 of piston 13 in the compression start condition can comprise the steps of:
A) detecting the pressure p of the hydraulic fluid acting on piston 13 in an advancement step (F1) without compression of piston 13 up to the occurrence of the compression start condition (FIG. 13, step M2A), B) determining a value of compression start position 22 of piston 13 in the compression start condition depending on pressure p detected in the piston advancement step F1 without compression, and on a calibration function 23 of the compression tool 1, where the calibration function 23 expresses the position of piston 13 along the actuation stroke 15 as a function of the pressure p of the hydraulic fluid in the absence of compression of an object 11 (FIG. 13, step M2B),

Alternatively to the step of determining the compression start position 22 described in the preceding paragraph (FIG. 13, step M2A, M2B), the step of determining the compression start position 22 can comprise:
A) detecting, in a piston advancement step F1 without compression up to the occurrence of the compression start condition, a spring force S applied by the at least one return spring 14 to piston 13 (FIG. 13, step M2A′),
B) determining a value of compression start position 22 of piston 13 in the compression start condition depending on the detected spring force S in the piston advancement step F1 without compression, and on a calibration function 23′ of the compression tool 1, where the calibration function 23′ expresses the position of piston 13 along the actuation stroke 15 as a function of the spring force S (FIG. 13, step M2B′).

The idea underlying the invention is to combine the identification of the instant of first contact of the object to be compressed, i.e., the actual start of compression, for example, depending on the (gradient variation of the) monitored hydraulic pressure p, with an identification of the compression start position 22 of piston 13, and therefore the identification of the non-deformed size of object 11 (for example, of an electrical contact, cable lug, etc.) to be compressed utilizing, for example, the knowledge of the pressure p of the hydraulic fluid, or alternatively, the knowledge of the reaction force S of the return spring 14, in each position of piston 13 along the actuation stroke 15 in the absence of a load or without the presence of an object 11 (electrical contact, cable lug) between the two jaws 8, 9.

This allows the position of piston 13 to be expressed:
in terms of pressure p of the hydraulic fluid (in the absence of compression of an object 11), or
in terms of force S of the return spring 14 (in the absence of compression of an object 11 and also in the presence of compression of an object 11),

thus obviating the need for a specific detection of position or distance, for example, by means of encoders, optical sensors, etc. Alternatively, it is possible to take advantage of the knowledge of (other) operating parameters of tool 1 detectable by means of sensors or available to the electronic control circuit.

The method allows an implementation mainly or completely at a software level, and thus is suitable for different structure types and concepts of hydrodynamic compression tools, in particular dieless ones.

In certain embodiments thereof, the method allows reducing the sensors used in the prior art for determining the position of the piston or jaws.

The method allows object 11, e.g., an electrical connector, a cable lug, a hydraulic connector, to be recognized in a more accurate manner (in the sense of a greater dimensional resolution), and determining an operating parameter or compression completion criterion in a more precise and accurate manner, for example, adjusting a target pressure pT of the hydraulic fluid and/or a target return spring force S_T (equivalent to the target piston stroke pos_T) and/or a target pumping action number np_T, which is required and sufficient to complete the compression, in a more precise and accurate manner.

This reduces the consumption of electricity and the mechanical stresses of the jaws 8, 9 and increases the autonomy (number of compressions executable by a battery charge) and the useful life of the compression tool 1.

### Determining Operating Parameters And/or Compression Completion Criteria

With reference to determining an operating parameter or a compression completion criterion, for example, the method can comprise the steps of:
determining a target pressure pT of the hydraulic fluid depending on the value of compression start position 22 and on a predetermined size-target pressure association 24 between values of compression start position 22, indicative of sizes of objects 11 to be compressed, and corresponding values of target pressure pT of the hydraulic fluid (FIG. 13, step M3.1), and for example
interrupting the actuation of the electric motor 6 upon reaching the determined target pressure pT of the hydraulic fluid.

Alternatively or in addition, the method can comprise the steps of:
determining a target spring force S_T of the return spring 14 depending on the value of compression start position 22 and on a predetermined size-target spring force association 24′ between values of compression start position 22, indicative of sizes of objects 11 to be compressed, and corresponding values of target spring force S_T expressing corresponding target piston positions pos_T (FIG. 13, step M3.2), and for example
interrupting the actuation of the electric motor 6 upon reaching the target spring force S_T of the return spring 14.

Alternatively or in addition, the method can comprise the steps of:
determining a target pumping action number np_T of the hydraulic pump 18 (or a corresponding number of revolutions of the electric motor 6), in particular, a counted number starting from the compression start condition, depending on the value of compression start position 22 and on a predetermined size-target pumping action number (or target motor revolution number) association 24″ between values of compression start position 22, indicative of sizes of objects 11 to be compressed, and corresponding values of target pumping action number (or target motor revolution number) np_T expressing, for example, corresponding target piston positions pos_T (FIG. 13, step M3.3), and for example
interrupting the actuation of the electric motor 6 upon reaching target pumping action number (or target motor revolution number) np_T.

The calibration function 23, 23′ has the advantage of adapting the information or association tables in a very flexible manner, for example, size-target pressure association 24, or size-target spring force association 24′ corresponding to a size-target piston stroke association, or size-target pumping action number association 24″, between the type of object (for example, type/size of cable lug or electrical contact) and the compression force or stroke prescribed by the manufacturer or legislation, to the specific conditions of the compression tool 1 without the need to modify or adapt these size-target pressure 24 and/or size-target spring force 24′ and/or size-target pumping action number 24″ associations to each modification of the compression tool 1.

### Detecting and Processing Pressure And/or Spring Force Values

The pressure p of the hydraulic fluid is detected by a pressure sensor 25 which provides a voltage value V_p corresponding to the detected pressure p. There is no need to calculate a value of pressure p of the hydraulic fluid [for example, expressed in MPa] based on the electric voltage values V_p provided by the pressure sensor 25. In order to reduce the engagement and calculation time, the voltage value V_p provided by the pressure sensor 25 can be used and processed as representing the value of pressure p of the hydraulic fluid.

The spring force S is detected by a force sensor 26 which provides a voltage value V_S corresponding to the detected spring force S. There is no need to calculate a value of force S of the return spring 14 [for example, expressed in N] based on the electric voltage values V_S provided by the force sensor 26. In order to reduce the engagement and calculation time, the voltage value V_S provided by the force sensor 26 can be used and processed as representing the spring force value S.

The calibration function 23, 23′ thus allows the position of piston 13 to be expressed directly:
in terms of electric voltage V_p provided by the pressure sensor 25 (only in the absence of compression of an object 11), or
in terms of electric voltage V_S provided by the force sensor 26 (in the absence of compression of an object 11 and also in the presence of compression of an object 11).

When pressure values p of the hydraulic fluid are discussed, it means both the possible expression of these values in terms of voltage V_p or of another feature of electrical signal provided by the pressure sensor 25, and a possible expression of these values in terms of pressure.

Similarly, when force values S of the return spring 14 are discussed, it means both the possible expression of these values in terms of voltage V_S or of another feature of electrical signal provided by the force sensor 25, and a possible expression of these values in terms of force.

### Description of the Generation of the Calibration Function 23, 23′

Since the properties of the return springs 14 (elastic constant of the spring, length, preload, placement surrounding conditions) are difficult to replicate in a strictly identical manner from one tool to the next, the calibration function 23, 23′ is preferably and advantageously determined experimentally, individually for each compression tool 1, for example, by actuating, in the absence of a load, the compression tool 1, and detecting the pressure p of the hydraulic fluid (FIGS. 9, 9A) and/or of the spring force S (FIGS. 11, 11A) for a plurality of positions of piston 13, or time steps or pumping steps of the hydraulic pump 18, during the movement of piston 13 along the actuation stroke 15 between the stroke start position 16 and the stroke end position 17.

A mapping of the pressure p of the hydraulic fluid and/or of the spring force S for creating the calibration function 23, 23′ can be performed, for example, as a function of pumping cycles of the hydraulic pump 18 or as a function of a cumulative number of revolutions of the electric motor 6 in case of hydraulic displacement pump 18 which conveys a constant volume at every pumping cycle, or as a function of time in case of a hydraulic pump 18 having a constant delivery flow rate.

Since the calibration function 23, 23′ is conventionally a linear function due to the linear-elastic property of the return spring 14, and the total actuation stroke 15 of the stroke start position 16 to the stroke end position 17 of piston 13 is known, it is advantageous to determine the calibration function 23 by:
performing a plurality of movement cycles of piston (13) in the absence of an object (11) along the actuation stroke (15) and detecting the pressure values (p_16) of the hydraulic fluid when piston (13) is in stroke start position (16) and the pressure values (p_17) of the hydraulic fluid when piston (13) is in stroke end position (17),
calculating an initial mean pressure value (p_16m) of the hydraulic fluid of the plurality of detected pressure values (p_16) of the hydraulic fluid for the stroke start position (16),
calculating a final mean pressure value (p_17m) of the hydraulic fluid of the plurality of detected pressure values (p_17) of the hydraulic fluid for the stroke end position (17),
determining the calibration function (23) by means of linear interpolation of the pressure (p) of the hydraulic fluid between the initial mean value (p_16m) in the stroke start position 16 and the final mean value (p_17m) in the stroke end position (17).

Alternatively, the calibration function 23′ can be determined by:
performing a plurality of movement cycles of piston (13) in the absence of an object (11) along the actuation stroke (15) and detecting the force values (S_16) of the return spring (14) when piston (13) is in stroke start position (16) and the force values (S_17) of the return spring (14) when piston (13) is in stroke end position 17),
calculating an initial mean spring force value (S_16m) of the plurality of detected spring force values (S_16) for the stroke start position (16),
calculating a final mean spring force value (S_17m) of the plurality of detected spring force values (S_17) for the stroke end position (17),
determining the calibration function (23′) by means of linear interpolation of the spring force(S) between the initial mean value (S_16m) in the stroke start position (16) and the final mean value (S_17m) in the stroke end position (17).

According to an embodiment, the abutment jaw 8 and the compression jaw 9 form part of a work head 32 pivotally connected to housing 2 of the compression tool 1, and the plurality of movement cycles of piston 13 comprises a plurality of movement cycles of piston 13 with the work head 32 rotated in a first angular position with respect to housing 2 and a plurality of movement cycles of piston 13 with the work head 32 rotated in a second angular position with respect to housing 2, which is different from the first angular position. This compensates for measuring differences for different positions of the work head 32 when determining the calibration function 23, 23′.

### Identifying Stroke Start and Stroke End Positions of the Piston

Advantageously, the method also comprises the step of identifying, preferably automatically identifying, the stroke start 16 and stroke end 17 positions of piston 13 and preferably also considering a possible variability of the elastic preload of the return spring 14 to piston 13 positioned in the stroke start position 16.

This further increases the determination accuracy of the compression start position 22.

In the stroke start position 16, piston 13 is in direct or indirect (resting) contact with a first abutment surface 27 (for example, of the hydraulic cylinder 12) and, upon the actuation of the hydraulic pump 18:
the pressure of the hydraulic fluid increases up to counter-balancing the preload force of the return spring 14, without yet moving piston 13 (FIGS. 9, 9A), and
only a further increase in the pressure of the hydraulic fluid, which overcomes the preload force of the return spring 14, moves piston 13 out of the stroke start position 16, determining an initial gradient variation 29 (step) in the trend of the value of detected pressure p of the hydraulic fluid (FIGS. 9, 9A) or an initial gradient variation 29′ in the trend of the value of detected spring force S (FIG. 11).

In the stroke start position 16 of piston 13, the detected pressure p of the hydraulic fluid will have a decrease in gradient (initial gradient variation 29) being a criterion for identifying the stroke start position 16 of piston 13.

In the stroke start position 16 of piston 13, the detected spring force S will have an increase in initial gradient 29′ (from gradient zero to a substantially constant gradient greater than zero) being a criterion for identifying the stroke start position 16 of piston 13.

Similarly, in the stroke end position 17:
piston 13 is in contact with or (directly or indirectly) resting against a second abutment surface 28 (for example, of the hydraulic cylinder 12 or the abutment jaw 8) and,
continuing the actuation of the hydraulic pump 18, the pressure gradient p of the hydraulic fluid increases with respect to the actuation without a load due to the rigidity of the second abutment surface 28,
   determining a final gradient variation 30 in the trend of the value of detected pressure of the hydraulic fluid (FIGS. 9, 9A) or, only under specific circumstances, a final gradient variation 30′ in the trend of the value of detected spring force (FIG. 11).

In the stroke end position 17 of piston 13, the detected pressure of the hydraulic fluid will have an increase in gradient (final gradient variation 30) being a criterion for identifying the stroke end position 17 of piston 13.

If, in the stroke end position 17 of piston 13, the return spring 14 is placed in series and squeezed between piston 13 and the second abutment surface 28, the detected spring force S will have an increase in gradient (final gradient variation 30′) being a criterion for identifying the stroke end position 17 of piston 13.

If, in the stroke end position 17 of piston 13, the return spring 14 is placed parallel and not squeezed between piston 13 and the second abutment surface 28, the detected spring force S will not have any increase in gradient (in the time domain in case of constant piston speed or in the space domain in any case) or will have a decrease in gradient (in the time domain in case of piston slowdown) (final gradient variation 30′) being a criterion for identifying the stroke end position 17 of piston 13.

According to an aspect of the invention, the stroke start 16 and stroke end 17 positions of piston 13 are identified based on the gradient variations 29, 30 of the detected pressure p of the hydraulic fluid and/or based on the gradient variations 29′, 30′ of the detected spring force S.

### Identifying the Compression Start Condition

Similarly, also the compression start condition can be identified or is identified based on a compression start gradient variation 31 of the detected pressure p of the hydraulic fluid (FIGS. 10, 10A).

### Description of the Object Size-Operating Parameter Associations

According to an embodiment, the size-target pressure association 24 can comprise a table of values and/or a set of mathematical formulas which correlate values or intervals of the object size and corresponding values of target pressure pT (FIG. 10B), for example, stored in a memory of an electronic control circuit 10 of the compression tool 1.

According to an embodiment, the size-target spring force association 24′ can comprise a table of values and/or a set of mathematical formulas which correlate values or intervals of the object size and corresponding values of target spring force S_T (FIG. 12B), for example, stored in a memory of an electronic control circuit 10 of the compression tool 1.

According to an embodiment, the size-target pumping action number association 24″ can comprise a table of values and/or a set of mathematical formulas which correlate values or intervals of the object size and corresponding values of target pumping action or motor revolution number np_T, for example, stored in a memory of an electronic control circuit 10 of the compression tool 1. According to a further embodiment, the method comprises the steps of:
counting the number of pumping actions of the hydraulic pump 18 from the compression start condition (instant of first contact of the object 11 with both jaws 8, 9) up to reaching the determined value of target pressure pT,
comparing the counted number of pumping actions with a predetermined number of pumping actions expected (expected pumping cycle number) to reach the determined value of target pressure pT, for example, the aforesaid target pumping action number np_T,

if the difference between the counted number of pumping actions and the predetermined number of expected pumping actions is less than a threshold value, returning a “compression successful” message,

if the difference between the counted number of pumping actions and the predetermined number of expected pumping actions is greater than the threshold value, returning a “compression failed” message, or a message of anomaly.

According to an embodiment, the method comprises the step of selecting the size-target pressure association 24 (or similarly, the size-target spring force association 24′ or the size-target pumping action number association 24″) from a plurality of predetermined size-target pressure associations 24 (or similarly, a plurality of size-target spring force associations 24′ or size-target pumping action number associations 24″) or modifying the size-target pressure association 24 (or similarly, the size-target spring force association 24′ or the size-target pumping action number association 24″) depending on the material (e.g., aluminum, copper) of the object 11 (electrical contact, cable lug) to be compressed.

To this end, the compression tool 1 can comprise a user interface 33 with a display connected to the electronic control circuit 10, which allows selecting the material of object 11, where the electronic control circuit 10 selects or modifies the size-target pressure association 24 (or similarly, the size-target spring force association 24′ or the size-target pumping action number association 24″) depending on the material selected by the user interface 33.

In order to implement the method described so far, the compression tool 1 can comprise a pressure sensor 25 positioned and configured to detect the pressure p of the hydraulic fluid acting on piston 13, optionally, the aforesaid force sensor 26, as well as an electronic control circuit 10 in signal connection with the pressure sensor 25, with the force sensor 26 (when provided) and with the electric motor 6.

### Description of the Return Spring 14

The return spring 14 can comprise:
one single elastic spring, for example, a single steel helical spring, or
two or more distinct elastic springs, for example, two or more steel helical springs placed, for example, in parallel (FIG. 3) or placed in series, and jointly forming a return spring set forming the return spring 14.

The term “spring force S” indicates the force transmitted by the return spring 14 consisting of a single spring or forming several distinct springs. According to embodiments, the term “spring force S” can also relate to the force transmitted by a single or by more than one of the distinct springs forming the return spring 14.

Indeed, in light of the present description, those skilled in the art will understand that a univocal relation between the measurement of elastic deformation and the resulting elastic reaction force of the spring can be individually established for each distinct spring or even for the set of all the springs pushing the piston towards the stroke start position thereof.

For this reason, when defining the structure of the present invention, the discussion focuses on “at least one return spring 14”, and when indicating the spring force, the discussion generally focuses on “spring force S” or “force S of the spring” or “force of the return spring 14”.

### Description of the Control Circuit 10

The electronic control circuit 10 is configured to process the signals from the pressure sensor 25 and force sensor 26 (when provided) and to control the electric motor 6 according to the above-described steps of the method.

The electronic control circuit 10 comprises a processing unit (CPU), an (internal or external) memory associated with the processing unit (CPU), a communication interface associated with the processing unit (CPU) and adapted to receive (pressure, force) signals from the pressure sensor 25 and force sensor 26 (when provided) and to transmit control signals to the electric motor 6. The control circuit 10 further comprises a computer program loaded in the memory and configured to process the signals and operations required to implement the method for operating tool 1. The control circuit 10 is connected to battery 5 (when battery 5 is coupled to tool 1) and could also have its own battery, possibly adapted to be charged when the control circuit 10 is connected to battery 5.

According to an embodiment, tool 1 comprises a user interface 33 with a display connected to the electronic control circuit 10, which is configured to cause, by means of such a user interface 33, a display and selection of operating parameters of the compression tool 1.

The pressure sensor 25 can comprise a pressure transducer, for example, a piezoelectric transducer housed in the housing 2 of the tool and in communication with the hydraulic fluid acting on piston 13. In particular, the pressure sensor 22 can have a measuring portion placed in the return duct 21 of hydraulic cylinder 12.

Advantageously, the memory of the electronic control circuit 10 is sized to store the detected and processed data of more than 200,000 compression cycles.

The electronic control circuit 10 is configured to execute the steps and functions described in relation to the method for operating the compression tool 1, which functions are therefore integrated in the compression tool 1 so as to be automatically executable or in response to user commands, and are not repeated herein for brevity.

The operation of the compression tool 1 is described below.

Pressing the operation button 7 actuates a microswitch of the electronic control circuit 10, which starts the electric motor 6 and simultaneously starts receiving and processing the signals indicative of the pressure of the hydraulic fluid provided by the pressure sensor 25. The control circuit 10 is configured so that the electric motor 6 remains ON only when the operation button 7 is pressed down, and therefore is automatically switched OFF with the release of such an operation button 7. Piston 13 starts advancing “empty” (without a load), nearing the abutment 8 and compression 9 jaws to object 11. The moment object 11 is engaged (compression start condition), it causes a resistance to a further nearing of the jaws, which causes a significant increase of the detected pressure p of the hydraulic fluid. The control circuit 10 determines the value of target pressure pT as a function of the compression start position 22 of piston 13. When the detected pressure p reaches the value of target pressure pT, the electronic control circuit 10 automatically switches OFF the electric motor 6. Now the operation button 7 can be released.

For the return of piston 13 to the stroke start position 16 thereof (jaws open), tool 1 can comprise a member or button 34 (FIG. 1) for manual operation, or alternatively, means for automatically operating a generic discharge valve or the maximum pressure valve of the hydraulic fluid from the hydraulic cylinder 12 into the tank of the hydraulic pump 18.

Advantageously, due to the operation of the discharge or maximum pressure valve, member 34 and the motor operation button 7 are configured so that with member 34 actuated, button 7 is locked and my not be pressed down or operated in order to prevent the electric motor 6 from being switched ON during the return of piston 13 to the stroke start position 16.

In case of voluntary interruption (by deactivating the electric motor 6 by releasing the operation button 7) of an incomplete compression cycle, it is advantageous to store the previously processed parameters so as to resume the compression from the point of voluntary interruption.

In case of involuntary interruption (by deactivating the electric motor 6) of an incomplete compression cycle, it is also advantageous to short circuit the electrical contacts of motor 6 so as to lock it in the interruption position in which it was deactivated, with a braking effect against movements out of the position of interruption.

### LIST OF REFERENCE SIGNS

hydrodynamic compression tool 1
housing 2
handle 3
battery coupling portion 4
electric battery 5
electric motor 6
operation button 7
abutment jaw 8
compression jaw 9
electronic control circuit 10
object 11
hydraulic cylinder 12
piston 13
return spring 14
actuation stroke 15
stroke start position 16
stroke end position 17
hydraulic pump 18
maximum pressure valve 19
tank 20
return duct 21
compression start position 22
calibration function 23, 23′
size-target pressure association 24
size-target spring force association 24′
pressure sensor 25
force sensor 26
first abutment surface 27
second abutment surface 28
initial gradient variation 29
final gradient variation 30
compression start gradient variation 31
work head 32
user interface 33 with display
return member 34
pressure p of the hydraulic fluid
spring force S
target pressure pT
voltage value V_p of the pressure sensor
voltage value V_S of the spring force sensor
piston advancement step F1 without compression
actuation stroke duration t_15
stroke start time t 16
stroke end time t_17
compression start time t 22
stroke start pressure p_16
stroke end pressure p_17
compression start pressure p_22
stroke start spring force S_16
stroke end spring force S_17
compression start spring force S_22
target position pos_T upon reaching the switch OFF criterion
target time t_T upon reaching the switch OFF criterion
target spring force S_T upon reaching the switch OFF criterion

1-17. (canceled)

18. A method for operating a hydrodynamic compression tool, said tool comprising:
an abutment jaw and a compression jaw movable with respect to the abutment jaw for compressing an object positioned between the abutment jaw and the compression jaw,
a hydraulic cylinder, a piston and at least one return spring which elastically pushes the piston to a stroke start position with respect to the hydraulic cylinder, wherein the piston is connected to the compression jaw and can translate with respect to the hydraulic cylinder along an actuation stroke between the stroke start position and a stroke end position,
a hydraulic pump with an electric motor actuatable to increase the pressure of a hydraulic fluid acting in the hydraulic cylinder on the piston so as to move the piston from the stroke start position to the stroke end position and thus move the compression jaw towards the abutment jaw, said method comprising:
moving the compression jaw towards the abutment jaw by actuating the hydraulic pump,
detecting the pressure of the hydraulic fluid acting on the piston,
identifying a compression start condition when the abutment jaw and the compression jaw both engage the object to be compressed,
determining a compression start position of the piston in the compression start condition,
determining an operating parameter or a compression completion criterion depending on the compression start position.

19. The method of claim 18, comprising:
determining a target pressure (pT) of the hydraulic fluid depending on the value of compression start position and on a predetermined size-target pressure association between values of compression start position, indicative of sizes of objects to be compressed, and corresponding values of target pressure (pT) of the hydraulic fluid, and/or
determining a target spring force (S_T) of the return spring depending on the value of compression start position and on a predetermined size-target spring force association between values of compression start position, indicative of sizes of objects to be compressed, and corresponding values of target spring force (S_T), and/or
determining a target pumping action number (np_T) of the hydraulic pump or a corresponding number of revolutions of the electric motor depending on the value of compression start position and on a predetermined size-target pumping action number association between values of compression start position, indicative of sizes of objects to be compressed, and
corresponding values of target pumping action number or target motor revolution number (np_T),
interrupting the actuation of the electric motor upon reaching at least one of the values of target pressure (pT), target spring force (S_T), target pumping action number or target motor revolution number (np T).

20. The method of claim 18, wherein:
the identification of the compression start condition occurs depending on the detected pressure of the hydraulic fluid,
the determination of the compression start position of the piston in the compression start condition comprises the steps of:
A) detecting the pressure of the hydraulic fluid acting on the piston in a piston advancement step (F1) without compression up to the occurrence of the compression start condition,
B) determining a value of compression start position of the piston in the compression start condition depending on the pressure of hydraulic fluid detected in the piston advancement step (F1) without compression and on a calibration function of the compression tool, wherein the calibration function expresses the position of the piston along the actuation stroke as a function of the pressure of the hydraulic fluid in the absence of compression of an object.

21. The method of claim 20, comprising:
detecting the pressure of the hydraulic fluid by means of a pressure sensor which provides a voltage value (V_p) corresponding to the detected pressure,
using the voltage value (V_p) provided by the pressure sensor as the value of pressure of the hydraulic fluid, wherein the calibration function expresses the position of the piston directly in terms of electric voltage value (V_p) provided by the pressure sensor.

22. The method of claim 18, wherein:
the identification of the compression start condition occurs depending on the detected pressure of the hydraulic fluid,
the determination of the compression start position of the piston in the compression start condition comprises:
A′ ) detecting, in a piston advancement step (F1) without compression up to the occurrence of the compression start condition, a spring force(S) applied by the at least one return spring to the piston,
B′) determining a value of compression start position of the piston in the compression start condition depending on the detected spring force(S) in the piston advancement step (F1) without compression, and on a calibration function of the compression tool, wherein the calibration function expresses the position of the piston along the actuation stroke as a function of the spring force (S).

23. The method of claim 22, comprising:
detecting the spring force(S) by means of a force sensor which provides a voltage value (V_S) corresponding to the detected spring force(S),
using the voltage value (V_S) provided by the force sensor as a value of spring force(S), wherein the calibration function expresses the position of the piston directly in terms of electric voltage value (V_S) provided by the force sensor.

24. The method of claim 20, comprising a step of determining the calibration function by:
performing a plurality of movement cycles of piston in the absence of an object along the actuation stroke and detecting the pressure values (p_16) of the hydraulic fluid when the piston is in stroke start position and the pressure values (p_17) of the hydraulic fluid when piston is in stroke end position,
calculating an initial mean pressure value (p 16m) of the hydraulic fluid of the plurality of detected pressure values (p_16) of the hydraulic fluid for the stroke start position, calculating a final mean pressure value (p 17m) of the hydraulic fluid of the plurality of detected pressure values (p_17) of the hydraulic fluid for the stroke end position,
determining the calibration function by means of linear interpolation of the pressure of the hydraulic fluid between the initial mean value (p 16m) in the stroke start position and the final mean value (p 17m) in the stroke end position.

25. The method of claim 22, comprising a step of determining the calibration function by:
performing a plurality of movement cycles of piston in the absence of an object along the actuation stroke and detecting the force values (S_16) of the return spring when the piston is in stroke start position and the force values (S_17) of the return spring when the piston is in stroke end position 17),
calculating an initial mean spring force value (S_16m) of the plurality of detected spring force values (S_16) for the stroke start position,
calculating a final mean spring force value (S 17m) of the plurality of detected spring force values (S_17) for the stroke end position,
determining the calibration function by means of linear interpolation of the spring force(S) between the initial mean value (S_16m) in the stroke start position and the final mean value (S_17m) in the stroke end position.

26. The method of claim 24, wherein the abutment jaw and the compression jaw form part of a work head pivotally connected to a housing of the compression tool, and the plurality of movement cycles of the piston comprises a plurality of movement cycles of the piston with the work head rotated in a first angular position with respect to the housing and a plurality of movement cycles of the piston with the work head rotated in a second angular position with respect to the housing, which is different from the first angular position.

27. The method of claim 18, comprising:
a step of automatically identifying the stroke start position of the piston using an initial gradient variation of the detected pressure of the hydraulic fluid as an identification criterion, and/or
a step of automatically identifying the stroke end position of the piston using a final gradient variation of the detected pressure of the hydraulic fluid as an identification criterion.

28. The method of claim 18, comprising automatically identifying the compression start condition based on a compression start gradient variation of the detected pressure of the hydraulic fluid.

29. The method of claim 19, wherein:
the size-target pressure association and/or
the size-target spring force association and/or
the size-target pumping action number association, comprises a table of values and/or a set of mathematical formulas which correlate values or intervals of the object size and corresponding target values (pT; S_T, np_T) stored in a memory of an electronic control circuit of the compression tool.

30. The method of claim 19, comprising:
selecting the size-target pressure association from a plurality of predetermined size-target pressure associations, or
modifying the size-target pressure association, and/or
selecting the size-target spring force association from a plurality of predetermined size-target spring force associations, or
modifying the size-target spring force association, and/or
selecting the size-target pumping action number association from a plurality of predetermined size-target pumping action number associations, or
modifying the size-target pumping action number association, depending on the material of the object to be compressed.

31. The method of claim 18, comprising:
counting the number of pumping actions of the hydraulic pump from the compression start condition up to reaching the determined value of target pressure (pT),
comparing the counted number of pumping actions with a predetermined number of pumping actions expected to reach the determined value of target pressure (pT),
if the difference between the counted number of pumping actions and the predetermined number of expected pumping actions is less than a threshold value, returning a “compression successful” message,
if the difference between the counted number of pumping actions and the predetermined number of expected pumping actions is greater than the threshold value, returning a “compression failed” message, or a message of anomaly.

32. A hydrodynamic compression tool, comprising:
an abutment jaw and a compression jaw movable with respect to the abutment jaw for compressing an object positioned between the abutment jaw and the compression jaw,
a hydraulic cylinder, a piston and at least one return spring which elastically pushes the piston to a stroke start position with respect to the hydraulic cylinder, wherein the piston is connected to the compression jaw and can translate with respect to the hydraulic cylinder along an actuation stroke between the stroke start position and a stroke end position,
a hydraulic pump with an electric motor actuatable to increase the pressure of a hydraulic fluid acting in the hydraulic cylinder on the piston so as to move the piston from the stroke start position to the stroke end position and thus move the compression jaw towards the abutment jaw,
a pressure sensor configured to detect the pressure of the hydraulic fluid acting on the piston,
an electronic control circuit in signal connection with the pressure sensor and the electric motor, said electronic control circuit being configured to:
moving the compression jaw towards the abutment jaw by actuating the hydraulic pump,
detect the pressure of the hydraulic fluid acting on the piston by means of the pressure sensor,
identifying a compression start condition when the abutment jaw and the compression jaw both engage the object to be compressed,
determine a compression start position of the piston in the compression start condition,
determining an operating parameter or a compression completion criterion depending on the compression start position.

33. The hydrodynamic compression tool of claim 32, wherein the electronic control circuit is configured to carry out a method comprising:
moving the compression jaw towards the abutment jaw by actuating the hydraulic pump,
detecting the pressure of the hydraulic fluid acting on the piston,
identifying a compression start condition when the abutment jaw and the compression jaw both engage the object to be compressed,
determining a compression start position of the piston in the compression start condition,
determining an operating parameter or a compression completion criterion depending on the compression start position.

34. The hydrodynamic compression tool of claim 32, comprising a force sensor configured to detect the spring force (S) acting on the piston,
wherein the electronic control circuit is in signal connection with the force sensor, said electronic control circuit being configured to:
determine the compression start position of the piston in the compression start condition, through the steps of:
A′ ) detecting a spring force(S) applied by the at least one return spring to the piston in a piston advancement step (F1) without compression up to the occurrence of the compression start condition,
B′) determining a value of compression start position of the piston in the compression start condition depending on the detected spring force(S) in the piston advancement step (F1) without compression, and on a calibration function of the compression tool, wherein the calibration function expresses the position of the piston along the actuation stroke as a function of the spring force(S).
